(19) United States
(12) Patent Application Publication
(10) Pub. No.: US 2004/0041708 A1
(43) Pub. Date: Mar. 4, 2004

(54) Monitoring and security systems

(75) Inventor: Mary Greenwaldt, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Mico Products, Inc., Minneapolis, MN

(21) Appl. No.: 10/228,589

(22) Filed: Aug. 27, 2002

(51) Int. Cl. G08B 13/14

(52) U.S. Cl. 340/571

(57) ABSTRACT

The present invention portable security system for use with a movable article. The system includes a microcontroller. The system also includes a sensor, connected to the microcontroller, which sends a signal to the microcontroller when the article is moved. The security system further includes an alarm for alerting a user when the protected item is moved. Typically, the alarm includes an audio alarm and a visual alarm.

### CROSS-REFERENCE TO RELATED APPLICATION(S)

None.

### BACKGROUND OF THE INVENTION

The present invention relates to security systems, and more specifically to portable monitoring and security systems for use on movable articles.

In today's society, theft and burglary are unfortunate and frequent occurrences. In response to this growing concern, various security and monitoring systems have been developed to thwart would-be criminals. Typically, such systems provide sensors which communicate with a controller. The sensors are typically infrared sensors triggered by body heat, sound sensors triggered by noise, or pressure and magnetic sensors triggered by the opening of doors and windows for sensing the presence of intruders. An alarm condition is declared by the controller when one of the sensors sends the controller a signal indicative of the alarm condition. In response to receiving such signal, the controller typically activates a local alarm to scare off the intruder.

Although these security systems are useful for the protection of large articles and places (such as houses, office buildings, construction sites, etc.), these systems do not prevent the theft of smaller articles that are also commonly subject to theft. Examples of such articles include bicycles, motorcycles, all-terrain vehicles, truck bed toppers, and sporting equipment. Furthermore, these security systems are not useful for monitoring an area or an individual in a noncriminal setting, such as preventing an elderly patient from wandering from a nursing care facility or preventing an infant from entering a medicine cabinet or cupboard. This is because prior art systems are designed to secure larger areas.

Thus, there is a need for security and monitoring systems that can be used to secure movable articles and that can be used to monitor an area in a noncriminal setting.

### BRIEF SUMMARY OF THE INVENTION

The present invention is a portable security system for use with a movable article. The system includes a microcontroller, detection means (such as a vibration sensor), and alarm means. The detection means is connected to the microcontroller, and sends a signal to the microcontroller when the article is moved. The alarm means for alerts a user when the protected item is moved. Typically, the alarm means includes an audio alarm and a visual alarm.

In a preferred embodiment, the system further includes a rigid housing which contains the microcontroller, the vibration sensor, and the alarm. The system also preferably includes a switch connected to the microcontroller, which engages the security system when toggled into the appropriate position. Finally, the system preferably includes an attaching means, located on an exterior of the housing, for attaching the security system to the article to be protected.

### BRIEF DESCRIPTION OF THE DRAWINGS

FIG. 1 is an exploded perspective view of a security system according to the first embodiment of the present invention.

FIG. 2 is an exploded perspective view of the security system of FIG. 1 viewed from a reverse angle.

FIG. 3 is a perspective view of the security system according to the first embodiment of the present invention attached to a bicycle.

FIG. 4 is an exploded perspective view of a security system according to a second embodiment of the present invention.

FIG. 5 is an exploded perspective view of the security system of FIG. 4 viewed from a reverse angle.

FIG. 6 is a perspective view of the security system according to the second embodiment of the present invention attached to a motorcycle.

FIG. 7 is an exploded perspective view of a monitoring system according to a third embodiment of the present invention.

FIG. 8 is an exploded perspective view of the monitoring system of FIG. 7 viewed from a reverse angle.

FIG. 9 is a perspective view of the monitoring system according to the third embodiment of the present invention attached to a door.

### DETAILED DESCRIPTION

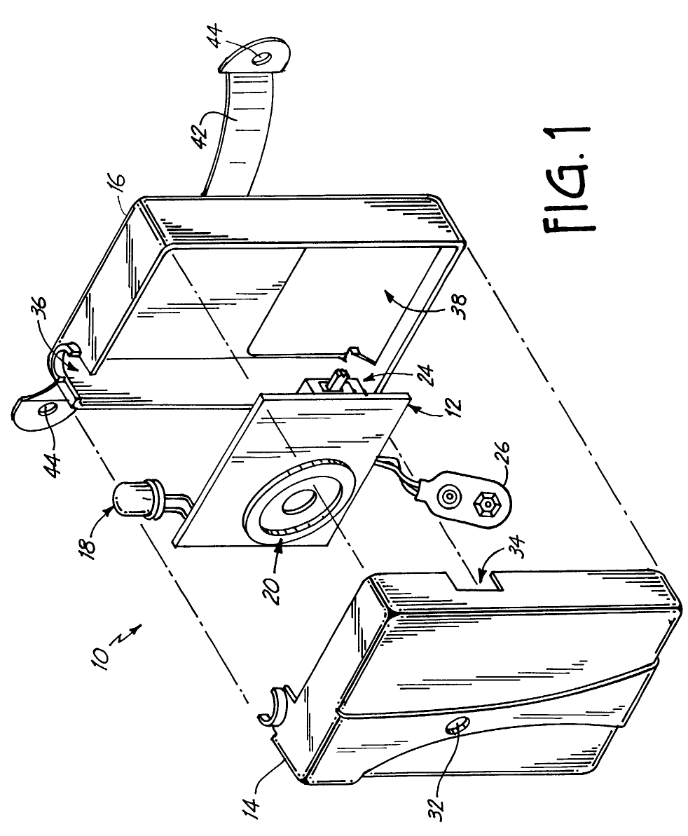

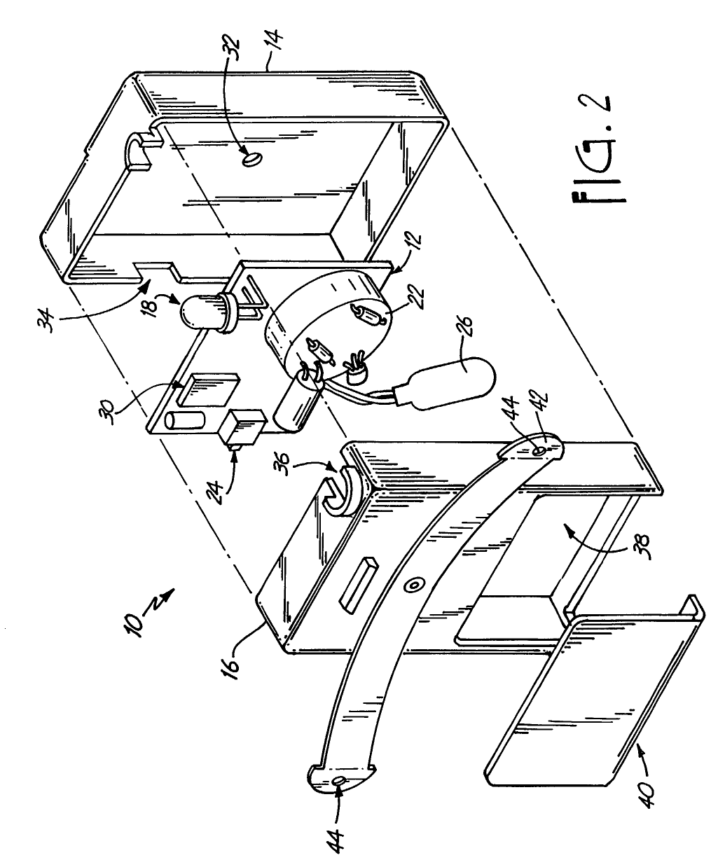

FIG. 1 is an exploded perspective view and FIG. 2 is a reverse exploded perspective view of security system 10 according to the first embodiment of the present invention. Security system 10 includes alarm circuit 12, upper housing 14, and lower housing 16. Alarm circuit 12 includes light-emitting diode (LED) 18, piezoelectric alarm 20, motion sensor 22, switch 24, battery electrode 26, and microcontroller 30. LED 18, piezoelectric alarm 20, motion sensor 22, switch 24, and battery electrode 26 are connected to microcontroller 30. During use, a battery (not shown) is connected to battery electrode 26. Upper housing 14 includes piezoelectric alarm aperture 32 and switch aperture 34. Lower housing 16 includes LED aperture 36, battery opening 38, battery compartment cover 40, and brace 42. Brace 42 includes securing holes 44.

When assembled, alarm circuit 12 is contained securely within upper housing 14 and lower housing 16. LED 18 is viewable through LED aperture 36, piezoelectric alarm 20 is audible through piezoelectric alarm aperture 32, switch 24 is accessible through switch aperture 34, and battery electrode 26 is accessible through battery opening 38 when alarm circuit 12 is contained within upper housing 14 and lower housing 16. Furthermore, battery 28 is insertable through battery opening 38 such that battery compartment cover 40 secures the battery between upper housing 14 and lower housing 16.

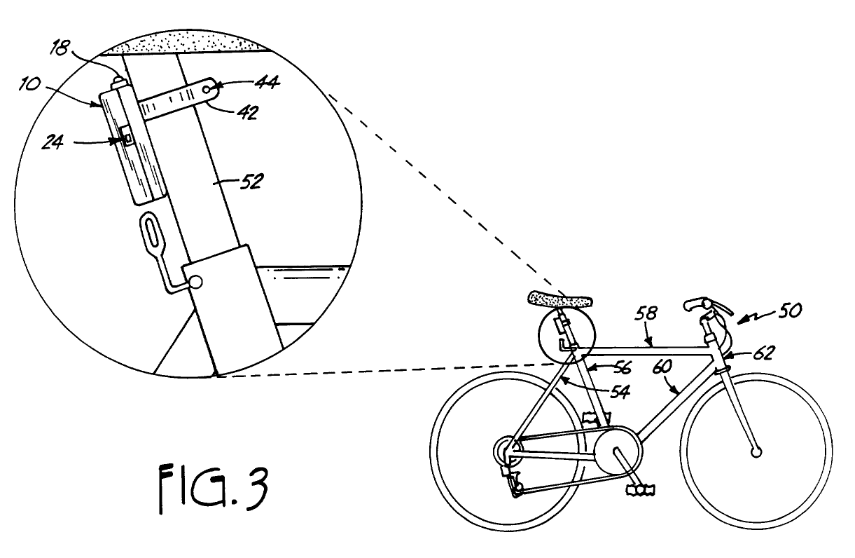

FIG. 3 is a perspective view of security system 10 according to the first embodiment of the present invention attached to bicycle 50. Security system 10 can also be attached to other movable articles, including sporting equipment (such as skis, athletic bags, or golf clubs), truck toppers, all-terrain vehicles, and motorcycles. For illustrative purposes, bicycle 50 is shown. Security system 10 is preferably attached to bicycle 50 by wrapping brace 42 around seat post 52. Brace 42 is preferably secured to seat post 52 by wrapping brace 42 around seat post 52, inserting a bolt (not shown) through holes 44, and threading a nut (not shown) onto the bolt. Security system 10 can also be attached to bicycle 50 using other attaching means, including metal screws, adhesives such as glue or tape, or any combination thereof. Furthermore, security system 10 can be attached to other parts of the frame of bicycle 50, including seat stay 54, seat tube 56, cross bar 58, down tube 60, and head tube 62.

After security system 10 is secured onto bicycle 50, security system 10 is activated by toggling switch 24 from the “off” position. Preferably, switch 24 is togglable to two “on” positions, a visual alarm mode or an audio alarm mode. Thus, switch 24 preferably has three positions. When switch 24 is switched to either visual alarm mode or audio alarm mode, any movement of bicycle 50 will cause motion sensor 22 to send a signal to microcontroller 30. Motion sensor 22 is preferably a vibration detector. Other detection devices can also be used for motion sensor 22, including an infrared motion detector or an ultrasonic motion detector. After receiving a signal from motion sensor 22, microcontroller 30 will send a signal to LED 18 (if switch 24 is toggled to visual alarm mode) or to piezoelectric alarm 20 (if switch 24 is toggled to audio alarm mode), thus triggering the alarm state of security system 10.

When security system 10 is activated, it is preferably deactivated by toggling switch 24 among its three positions in a predetermined order. The order of toggling is predetermined by the manufacturer and differs for each security system. As an example, security system 10 may require the following toggling order for switch 24 in order for security system 10 to be deactivated: OFF-VISUAL MODE-OFF. Thus, until switch 24 is toggled in this order, security system 10 will remain activated. Similarly, if security system 10 has been triggered (by moving bicycle 50, for example), switch 24 must be toggled in the predetermined order in order to terminate the alarm state LED 18 or piezoelectric alarm 20. The complexity of the required toggling order of switch 24 is variable from simple (requiring only one or two toggles) to complex (requiring several toggles).

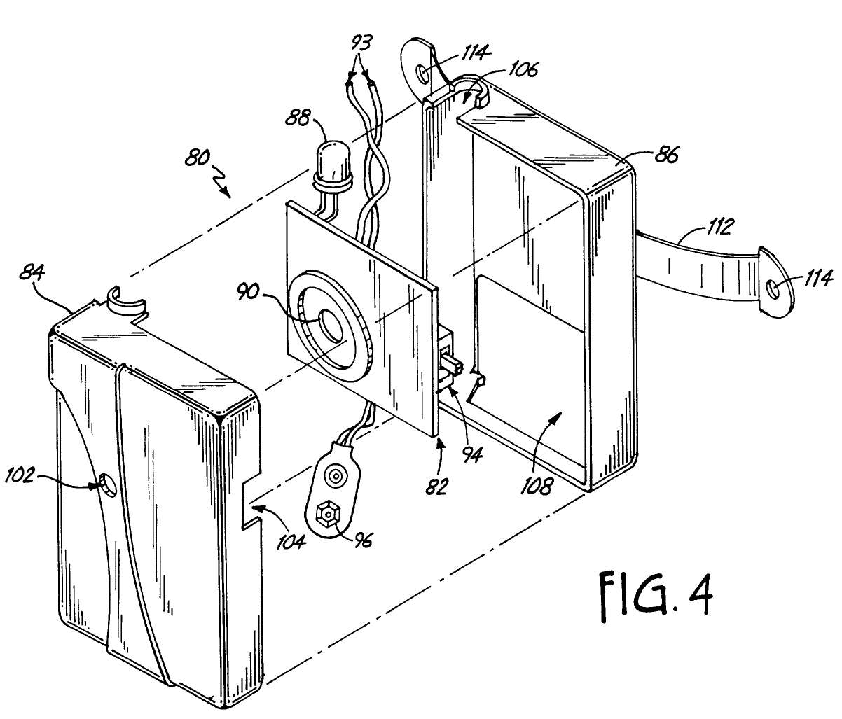

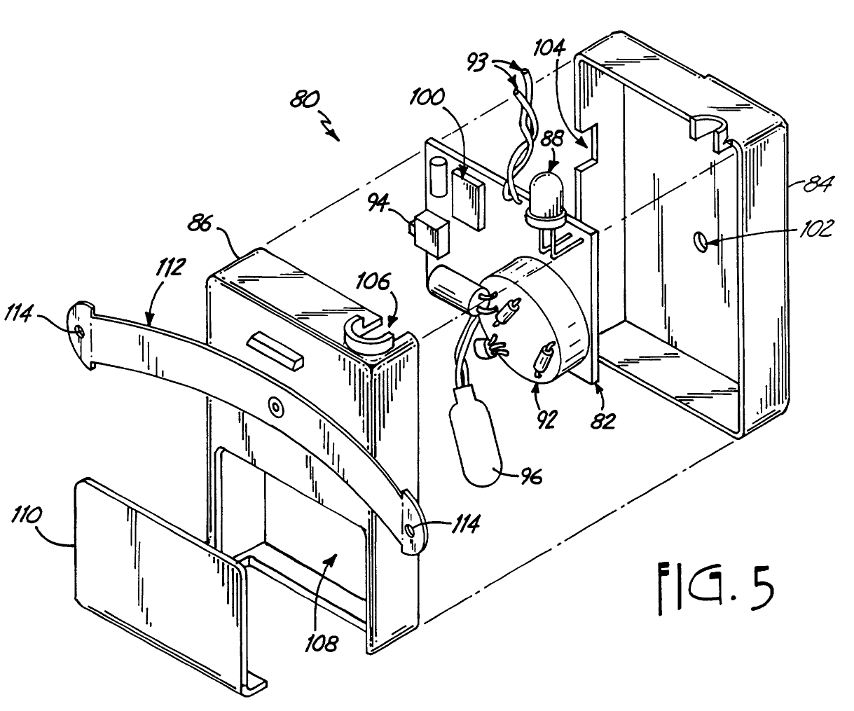

FIG. 4 is an exploded perspective view and FIG. 5 is a reverse exploded perspective view of security system 80 according to a second embodiment of the present invention. Security system 80 includes alarm circuit 82, upper housing 84, and lower housing 86. Alarm circuit 82 includes light-emitting diode (LED) 88, piezoelectric alarm 90, motion sensor 92, ignition wires 93, switch 94, battery electrode 96, and microcontroller 100. LED 88, piezoelectric alarm 90, motion sensor 92, ignition wires 93, switch 94, and battery electrode 96 are connected to microcontroller 100. During use, a battery (not shown) is connected to battery electrode 96. Upper housing 84 includes piezoelectric alarm aperture 102, and switch aperture 104. Lower housing 86 includes LED aperture 106, battery opening 108, battery compartment cover 110, and brace 112. Brace 112 includes securing holes 114.

When assembled, alarm circuit 82 is contained securely within upper housing 84 and lower housing 86. LED 88 is viewable through LED aperture 106, piezoelectric alarm 90 is audible through piezoelectric alarm aperture 102, switch 94 is accessible through switch aperture 104, and battery electrode 96 is accessible through battery opening 108 when alarm circuit 82 is contained within upper housing 84 and lower housing 86. Furthermore, the battery is insertable through battery opening 108 such that battery compartment cover 110 secures battery 98 between upper housing 84 and lower housing 86.

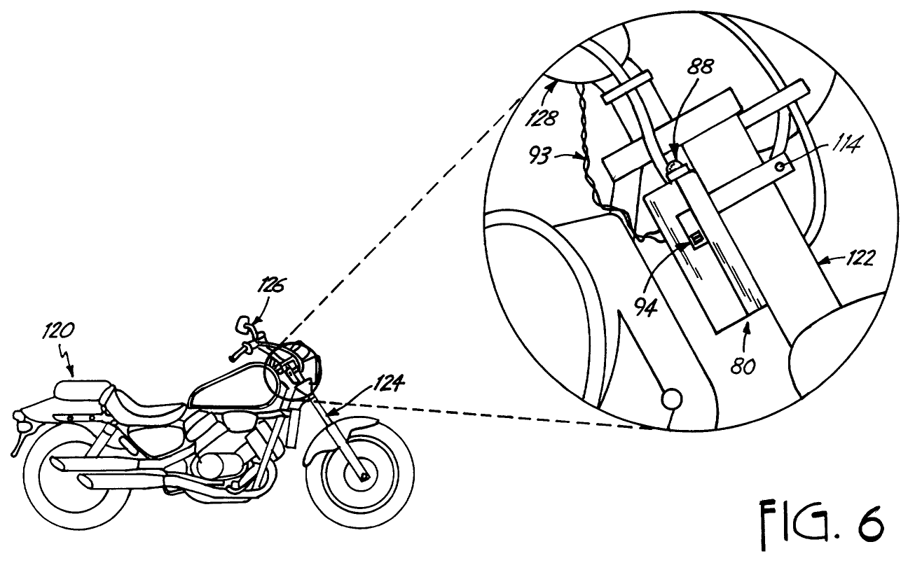

FIG. 6 is a perspective view of security system 80 according to the second embodiment of the present invention attached to motorcycle 120. Security system 80 can also be attached to other motorized vehicles, including all-terrain vehicles, snowmobiles, and mopeds. For illustrative purposes, motorcycle 120 is shown. Security system 80 is preferably attached to motorcycle 120 by wrapping brace 112 around head tube 122. Brace 112 is preferably secured to head tube 122 by wrapping brace 112 around head tube 122, inserting a bolt (not shown) through holes 114, and threading a nut (not shown) onto the bolt. Security system 80 can also be attached to motorcycle 120 using other attaching means, including metal screws, adhesives such as glue or tape, or any combination thereof. Furthermore, security system 80 can be attached to other parts of the frame of motorcycle 120, including wheel tube 124 and mirror brace 126. Installation is completed by connecting ignition wires 93 to ignition 128.

After security system 80 is secured onto motorcycle 120, security system 80 is activated by toggling switch 94 from the “off” position. Preferably, switch 94 is togglable to two “on” positions, a visual alarm mode or an audio alarm mode. Thus, switch 94 preferably has three positions. When switch 94 is switched to either visual alarm mode or audio alarm mode, any movement of motorcycle 120 will cause motion sensor 92 to send a signal to microcontroller 100. Motion sensor 92 is preferably a vibration detector. Other detection devices can also be used for motion sensor 92, including an infrared motion detector or an ultrasonic motion detector. After receiving a signal from motion sensor 92, microcontroller 100 will send a signal to LED 88 (if switch 94 is toggled to visual alarm mode) or to piezoelectric alarm 90 (if switch 94 is toggled to audio alarm mode), thus triggering the alarm state of security system 80.

When security system 80 is activated, it is preferably deactivated by starting ignition 128 or by toggling switch 94 among its three positions in a predetermined order. The former mode of deactivation allows the user to start and ride motorcycle 120 without requiring the latter mode of deactivation. Thus, when ignition 128 is started, security system 80 is deactivated. After ignition 128 is turned off, security system 80 returns to active mode. Furthermore, security system 80 cannot be deactivated by cutting ignition wires 93 because security system 80 is deactivated only when ignition 128 relays a signal through ignition wires 93 to security system 80. A signal is not relayed to security system 80 when ignition wires 93 are cut. Thus, security system 80 will remain activated until switch 94 is toggled in the predetermined order.

For deactivation by toggling switch 94, the order of toggling is predetermined by the manufacturer and differs for each security system. As an example, security system 80 may require the following toggling order for switch 94 in order for security system 80 to be deactivated: OFF-VISUAL MODE-OFF. Thus, until switch 94 is toggled in this order, security system 80 will remain activated. Similarly, if security system 80 has been triggered (by moving motorcycle 120, for example), switch 94 must be toggled in the predetermined order in order to terminate the alarm state LED 88 or piezoelectric alarm 90. The complexity of the required toggling order of switch 94 is variable from simple (requiring only one or two toggles) to complex (requiring several toggles).

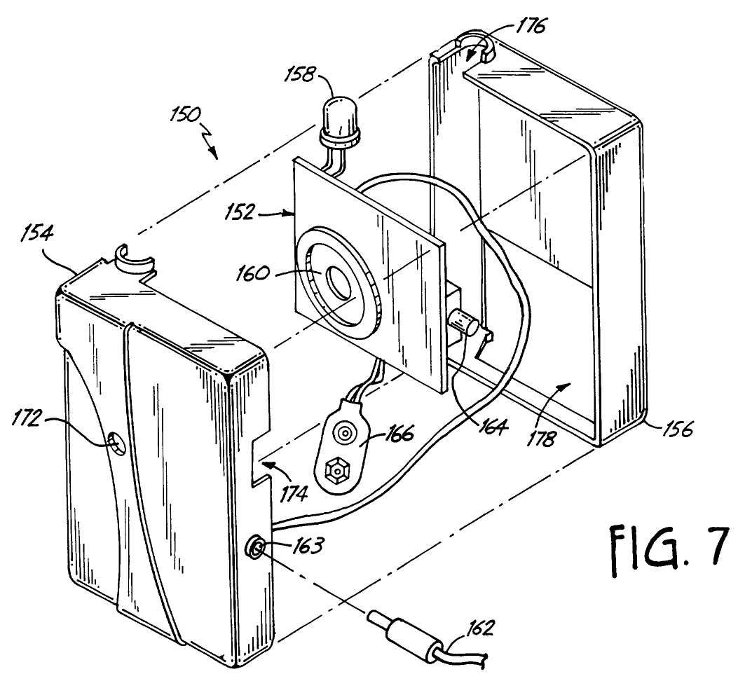

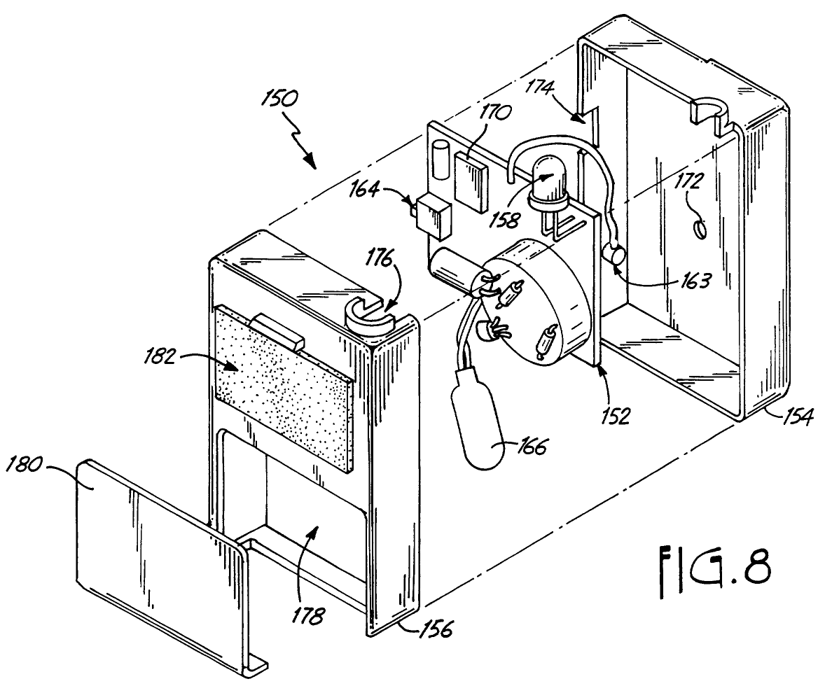

FIG. 7 is an exploded perspective view and FIG. 8 is a reverse exploded perspective view of monitoring system 150 according to a third embodiment of the present invention. Monitoring system 150 includes alarm circuit 152, upper housing 154, and lower housing 156. Alarm circuit 152 includes light-emitting diode (LED) 158, piezoelectric alarm 160, trip cord 162, button 164, battery electrode 166, and microcontroller 170. LED 158, piezoelectric alarm 160, trip cord 162, outlet 163, button 164, and battery electrode 166 are connected to microcontroller 170. During use, a battery (not shown) is connected to battery electrode 166. Upper housing 154 includes piezoelectric alarm aperture 172, and button aperture 174. Lower housing 156 includes LED aperture 176, battery opening 178, battery compartment cover 180, and securing tape 182.

When assembled, alarm circuit 152 is contained securely within upper housing 154 and lower housing 156. LED 158 is viewable through LED aperture 176, piezoelectric alarm 160 is audible through piezoelectric alarm aperture 172, button 164 is accessible through switch aperture 174, and battery electrode 166 is accessible through battery opening 178 when alarm circuit 152 is contained within upper housing 154 and lower housing 156. Furthermore, the battery is insertable through battery opening 178 such that battery compartment cover 180 secures battery 168 between upper housing 154 and lower housing 156.

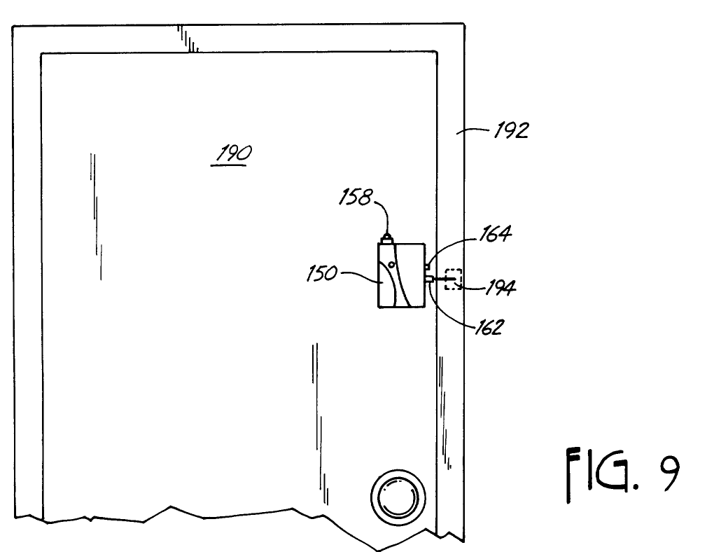

FIG. 9 is a perspective view of monitoring system 150 according to the third embodiment of the present invention attached to door 190. Monitoring system 150 can also be attached to other areas to be protected, including cupboards and medicine cabinets. For illustrative purposes, door 190 is shown. Monitoring system 150 is preferably attached to door 190 by using securing tape 182. Monitoring system 150 can also be attached to door 190 using other attaching means, including wood screws, a brace, or nails. Installation is completed by connecting trip cord 162 to doorjamb 192 using tape 194 or other adhesive.

After monitoring system 150 is secured onto door 190, monitoring system 150 is activated by pressing button 164. Preferably, button 164 is pressed once for a delayed activation and twice for a quick activation. When monitoring system 150 is activated, a signal is sent to microcontroller 170 when door 190 is opened and trip cord 162 is pulled from outlet 163. Other detection devices can also be used for monitoring system 150, including an infrared motion detector or a vibration detector. After receiving a signal when trip cord 162 is pulled from outlet 163, microcontroller 170 will send a signal to LED 158 and to piezoelectric alarm 160, thus triggering the alarm state of monitoring system 150.

When monitoring system 150 is activated or when the alarm is sounding, monitoring system 150 is preferably deactivated by pressing button 164 three times. This sends a signal to microcontroller 170, which allows the user to freely open the monitored article without monitoring system 150 entering the alarm state. Furthermore, after monitoring system 150 has been deactivated, it can be moved and attached to a new location to be monitored.

Monitoring system 150 is particularly useful in areas for monitoring small children, such as in a nursery and in a daycare, or in areas for monitoring the care of elderly patients, such as in nursing homes and in hospice care.

The present invention involves portable systems for securing movable articles and monitoring areas. The first embodiment of the present invention is a security system for attaching to a movable article such as a bicycle or sporting equipment. The system is sensitive to movement, and thus the alarm is activated when the article is moved. The second embodiment of the present invention is a security system for attaching to a movable motorized article, such as a motorcycle or an all-terrain vehicle. This embodiment incorporates a set of wires to be attached to the ignition of the motorized article. When the ignition wires are attached, the system is deactivated when the ignition is started on the motorized article. When the ignition is turned off, the system is reactivated. The system cannot be deactivated by cutting the ignition wires. The third embodiment of the present invention is a monitoring system for attaching to a door, medicine cabinet, cupboard, or other area to be monitored. This embodiment utilizes a cord to be attached to a doorjamb. When the cord is attached to the doorjamb and the system is turned on, the alarm is activated when the door, medicine cabinet, or cupboard is opened and the cord is pulled from the monitoring system.

Although the present invention has been described with reference to preferred embodiments, workers skilled in the art will recognize that changes may be made in form and detail without departing from the spirit and scope of the invention.

1. A portable security system, for use with a movable article, the security system comprising:
a microcontroller;
detection means, connected to the microcontroller, which sends a signal to the microcontroller when the article is moved; and
alarm means, connected to the microcontroller, for alerting a user when the article is moved.

2. The security system of claim 1, wherein the detection means comprises a motion sensor.

3. The security system of claim 1, wherein the detection means comprises a cord having a first end removably connected to the microcontroller and a second end attachable to a stationary article.

4. The security system of claim 3, wherein the alarm means alerts the user when the first end of the string is removed from the microcontroller.

5. The security system of claim 1, wherein the alarm means comprises a visual alarm and an audio alarm.

6. The security system of claim 5, wherein the visual alarm is a light-emitting diode.

7. The security system of claim 5, wherein the audio alarm is a piezoelectric alarm.

8. The security system of claim 1, further comprising:
a rigid housing which contains the microcontroller, the detection means, and the alarm means;
an activation means connected to the microcontroller for activating the security system; and
attaching means, located on an exterior of the housing, for attaching the security system to the movable article.

9. The security system of claim 8, wherein the attaching means is a metal brace.

10. The security system of claim 8, wherein the housing comprises a plurality of apertures to facilitate the alarm means and the activation means for use external to the housing.

11. The security system of claim 8, wherein the activation means is a button.

12. The security system of claim 8, wherein the activation means is a switch.

13. The security system of claim 12, wherein the switch is togglable by the user to one of three positions.

14. The security system of claim 13, wherein, when the security system is activated, the switch is toggled between the three positions in a predetermined order to deactivate the security system.

15. The security system of claim 1, further comprising:
wires connected to the microcontroller which are attachable to a motorized vehicle ignition.

16. The security system of claim 15, wherein, when the wires are attached to the motorized vehicle ignition, the security system is deactivated when the motorized vehicle ignition is started.

17. A portable security system, for use with a movable article which is commonly subject to theft, the security system comprising:
a microcontroller;
a motion sensor, connected to the microcontroller, which sends a signal to the microcontroller when the article is moved; and
an alarm, connected to the microcontroller, for alerting a user when the article is moved.

18. The security system of claim 17, wherein the alarm comprises a visual alarm and an audio alarm.

19. The security system of claim 17, further comprising:
a rigid housing which contains the microcontroller, the vibration sensor, and the alarm;
a switch connected to the microcontroller for activating the security system; and
a fastener, located on an exterior of the housing, for fastening the security system to the movable article.

20. The security system of claim 19, wherein the switch is togglable by the user to one of three positions.

21. The security system of claim 20, wherein, when the security system is activated, the switch is toggled between the three positions in a predetermined order to deactivate the security system.

22. The security system of claim 17, further comprising:
wires having a first end connected to the microcontroller and a second end which is attachable to a motorized vehicle ignition.

23. The security system of claim 22, wherein the security system is deactivated when the motorized vehicle ignition is started.
